(19) United States
(12) Patent Application Publication
(10) Pub. No.: US 2014/0299674 A1
(43) Pub. Date: Oct. 9, 2014

(54) MICRO SYNTHETIC JET EJECTOR

(71) Applicant: NUVENTIX, INC., Austin, TX (US)

(72) Inventor: Jeffrey Ross Uibel, Mountain View (CA)

(73) Assignee: NUVENTIX, INC., Austin, TX (US)

(21) Appl. No.: 14/200,574

(22) Filed: Mar. 7, 2014

Related U.S. Application Data
(60) Provisional application No. 61/809,536, filed on Apr. 8, 2013.

(51) Int. Cl. B05B 17/00

(52) U.S. Cl. CPC B05B 17/0646
USPC 239/102.2

(57) ABSTRACT

A semiconductor device is provided which functions as a synthetic jet ejector. The semiconductor device (201) includes a first layer (203), a third layer (207), and a second layer (205) disposed between the first layer and the third layer, wherein the second layer includes a MEMS comb drive (221). The device has a plurality of apertures therein (209, 211, 213, 215 and 217) which are in fluidic communication with the comb drive and which are also in fluidic communication with the external environment. The comb drive operates to generate a plurality of synthetic jets at the plurality of apertures.

This application claims the benefit of U.S. Provisional Application No. 61/809,536, filed Apr. 8, 2013, having the same title, and having the same inventor, and which is incorporated herein by reference in its entirety.

### FIELD OF THE DISCLOSURE

The present disclosure relates generally to synthetic jet ejectors, and more particularly to synthetic jet ejectors which may be made as semiconductor devices on the micro or nano scale.

### BACKGROUND OF THE DISCLOSURE

A variety of thermal management devices are known to the art, including conventional fan based systems, piezoelectric systems, and synthetic jet ejectors. The latter type of system has emerged as a highly efficient and versatile thermal management solution, especially in applications where thermal management is required at the local level.

Various examples of synthetic jet ejectors are known to the art. Earlier examples are described in U.S. Pat. No. 5,758,823 (Glezer et al.), entitled “Synthetic Jet Actuator and Applications Thereof”; U.S. Pat. No. 5,894,990 (Glezer et al.), entitled “Synthetic Jet Actuator and Applications Thereof”; U.S. Pat. No. 5,988,522 (Glezer et al.), entitled Synthetic Jet Actuators for Modifying the Direction of Fluid Flows“; U.S. Pat. No. 6,056,204 (Glezer et al.), entitled “Synthetic Jet Actuators for Mixing Applications”; U.S. Pat. No. 6,123,145 (Glezer et al.), entitled Synthetic Jet Actuators for Cooling Heated Bodies and Environments”; and U.S. Pat. No. 6,588,497 (Glezer et al.), entitled “System and Method for Thermal Management by Synthetic Jet Ejector Channel Cooling Techniques”.

Further advances have been made in the art of synthetic jet ejectors, both with respect to synthetic jet ejector technology in general and with respect to the applications of this technology. Some examples of these advances are described in U.S. 20100263838 (Mahalingam et al.), entitled “Synthetic Jet Ejector for Augmentation of Pumped Liquid Loop Cooling and Enhancement of Pool and Flow Boiling”; U.S. 20100039012 (Grimm), entitled “Advanced Synjet Cooler Design For LED Light Modules”; U.S. 20100033071 (Heffington et al.), entitled “Thermal management of LED Illumination Devices”; U.S. 20090141065 (Darbin et al.), entitled “Method and Apparatus for Controlling Diaphragm Displacement in Synthetic Jet Actuators”; U.S. 20090109625 (Booth et al.), entitled Light Fixture with Multiple LEDs and Synthetic Jet Thermal Management System“; U.S. 20090084866 (Grimm et al.), entitled Vibration Balanced Synthetic Jet Ejector”; U.S. 20080295997 (Heffington et al.), entitled Synthetic Jet Ejector with Viewing Window and Temporal Aliasing”; U.S. 20080219007 (Heffington et al.), entitled “Thermal Management System for LED Array”; U.S. 20080151541 (Heffington et al.), entitled “Thermal Management System for LED Array”; U.S. 20080043061 (Glezer et al.), entitled “Methods for Reducing the Non-Linear Behavior of Actuators Used for Synthetic Jets”; U.S. 20080009187 (Grimm et al.), entitled “Moldable Housing design for Synthetic Jet Ejector”; U.S. 20080006393 (Grimm), entitled Vibration Isolation System for Synthetic Jet Devices”; U.S. 20070272393 (Reichenbach), entitled “Electronics Package for Synthetic Jet Ejectors”; U.S. 20070141453 (Mahalingam et al.), entitled “Thermal Management of Batteries using Synthetic Jets”; U.S. 20070096118 (Mahalingam et al.), entitled “Synthetic Jet Cooling System for LED Module”; U.S. 20070081027 (Beltran et al.), entitled “Acoustic Resonator for Synthetic Jet Generation for Thermal Management”; U.S. 20070023169 (Mahalingam et al.), entitled “Synthetic Jet Ejector for Augmentation of Pumped Liquid Loop Cooling and Enhancement of Pool and Flow Boiling”; U.S. 20070119573 (Mahalingam et al.), entitled “Synthetic Jet Ejector for the Thermal Management of PCI Cards”; U.S. 20070119575 (Glezer et al.), entitled “Synthetic Jet Heat Pipe Thermal Management System”; U.S. 20070127210 (Mahalingam et al.), entitled “Thermal Management System for Distributed Heat Sources”; U.S. 20070141453 (Mahalingam et al.), entitled “Thermal Management of Batteries using Synthetic Jets”; U.S. Pat. No. 7,252,140 (Glezer et al.), entitled “Apparatus and Method for Enhanced Heat Transfer”; U.S. Pat. No. 7,606,029 (Mahalingam et al.), entitled “Thermal Management System for Distributed Heat Sources”; U.S. Pat. No. 7,607,470 (Glezer et al.), entitled “Synthetic Jet Heat Pipe Thermal Management System”; U.S. Pat. No. 7,760,499 (Darbin et al.), entitled “Thermal Management System for Card Cages”; U.S. Pat. No. 7,768,779 (Heffington et al.), entitled “Synthetic Jet Ejector with Viewing Window and Temporal Aliasing”; U.S. Pat. No. 7,784,972 (Heffington et al.), entitled “Thermal Management System for LED Array”; and U.S. Pat. No. 7,819,556 (Heffington et al.), entitled “Thermal Management System for LED Array”.

### BRIEF DESCRIPTION OF THE DRAWINGS

FIGS. 1A-1C are illustrations depicting the manner in which a synthetic jet actuator operates.

FIG. 2 is a perspective view of an embodiment of a micro synthetic jet ejector in accordance with the teachings herein.

FIG. 3 is an exploded view of the micro synthetic jet ejector of FIG. 2.

FIG. 4 is a perspective view of the micro synthetic jet ejector of FIG. 2 with the first layer removed therefrom, and depicting the MEMS comb drive in a first (expanded) state.

FIG. 5 is a perspective view of the micro synthetic jet ejector of FIG. 2 with the first layer removed therefrom, and depicting the MEMS comb drive in a second (c0ntracted) state.

FIG. 6 is an illustration of the basic configuration of a comb actuator.

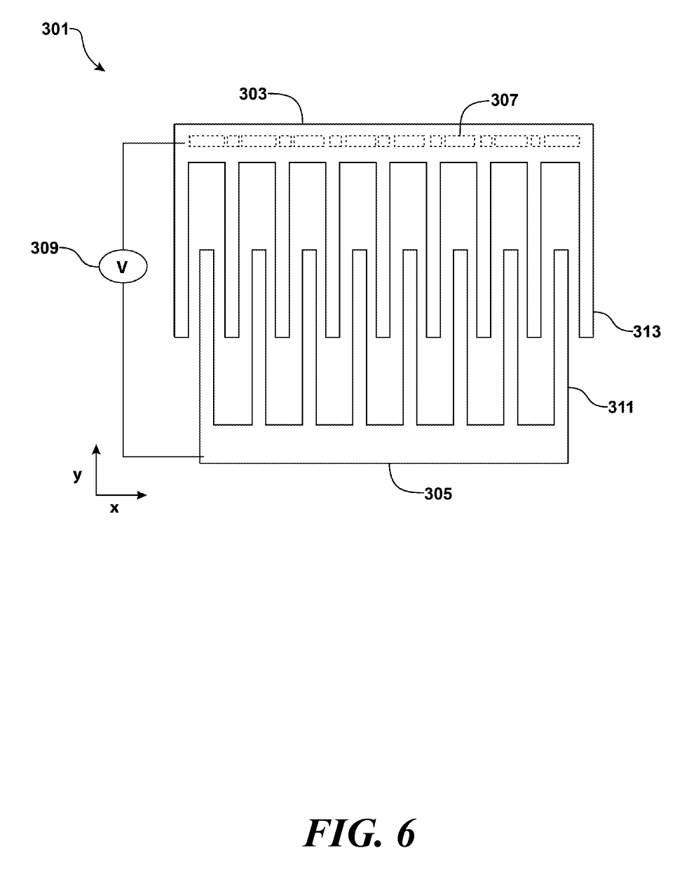

### SUMMARY OF THE DISCLOSURE

In one aspect, a semiconductor device which functions as a synthetic jet ejector is provided. The device comprises (a) a first layer; (b) a third layer; and (c) a second layer disposed between said first layer and said third layer; wherein said second layer comprises a MEMS comb drive, wherein said device has a plurality of apertures therein which are in fluidic communication with said comb drive and which are also in fluidic communication with the external environment, and wherein said comb drive operates to generate a plurality of synthetic jets at said plurality of apertures.

In another aspect, a synthetic jet ejector is provided which comprises a housing having a plurality of apertures defined therein; a comb drive disposed within said housing which includes (a) a moving electrode equipped with a first set of protrusions, and (b) a fixed electrode equipped with a second set of protrusions which are arranged in an interdigitating manner with respect to said first set of protrusions; and a controller which drives said comb drive to create at least one synthetic jet at said plurality of apertures, preferably by modifying the distance between said moving electrode and said fixed electrode.

### DETAILED DESCRIPTION

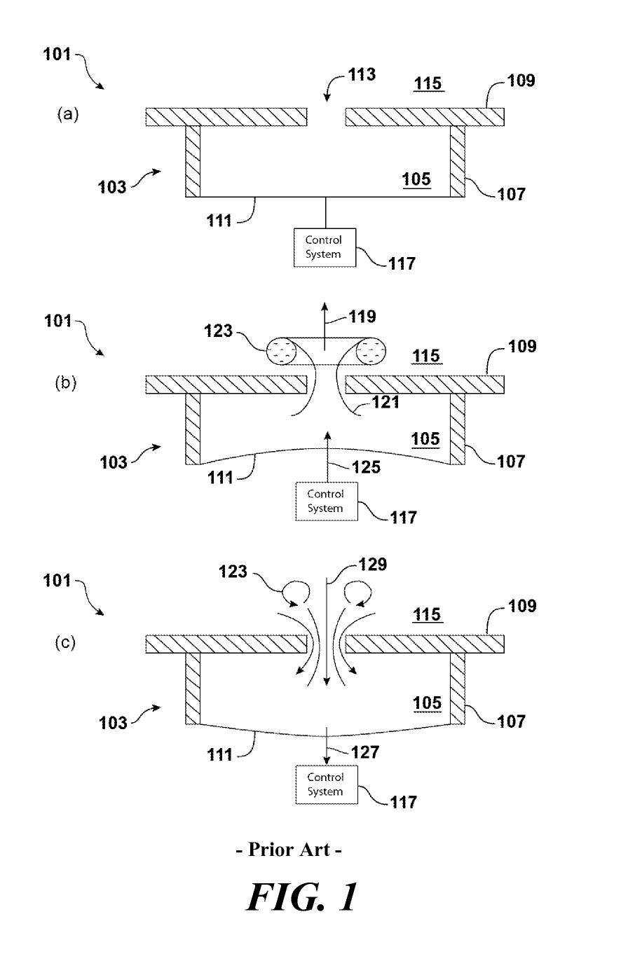

Prior to further describing the systems and methodologies disclosed herein, a brief overview of synthetic jet actuators may be helpful. The operation of a synthetic jet ejector and the formation of a synthetic jet may be appreciated with respect to FIGS. 1A-1C. FIG. 1A depicts a synthetic jet actuator 10 comprising a housing 11 defining and enclosing an internal chamber 14. The housing 11 and chamber 14 may have virtually any geometric configuration, but for purposes of discussion and understanding, the housing 11 is shown in cross-section in FIG. 1A as having a rigid side wall 12, a rigid front wall 13, and a rear diaphragm 18 that is flexible to an extent to permit movement of the diaphragm 18 inwardly and outwardly relative to the chamber 14. The front wall 13 has an orifice 16 of any geometric shape. The orifice diametrically opposes the rear diaphragm 18 and connects the internal chamber 14 to an external environment having ambient fluid 39.

The flexible diaphragm 18 may be controlled to move by any suitable control system 24. For example, the diaphragm 18 may be equipped with a metal layer, and a metal electrode may be disposed adjacent to, but spaced apart from, the metal layer so that the diaphragm 18 may be moved via an electrical bias imposed between the electrode and the metal layer. Moreover, the generation of the electrical bias may be controlled by any suitable device, for example but not limited to, a computer, logic processor, or signal generator. The control system 24 may cause the diaphragm 18 to move periodically, or modulate in time-harmonic motion, and force fluid in and out of the orifice 16.

Alternatively, a piezoelectric actuator may be attached to the diaphragm 18. The control system would, in that case, cause the piezoelectric actuator to vibrate and thereby move the diaphragm 18 in a time-harmonic motion. The method of causing the diaphragm 18 to modulate is not specifically limited.

The operation of the synthetic jet actuator 10 may be appreciated with reference to FIGS. 1B and 1C. FIG. 1B depicts the synthetic jet actuator 10 as the diaphragm 18 is controlled to move inward into the chamber 14, as depicted by arrow 26. The volume of the chamber 14 is consequently decreased, thus causing fluid to be ejected through the orifice 16. As the fluid exits the chamber 14 through the orifice 16, the flow separates at sharp orifice edges 30 and creates vortex sheets 32 which roll into vortices 34 and begin to move away from the orifice edges 30 in the direction indicated by arrow 36.

FIG. 1C depicts the synthetic jet actuator 10 as the diaphragm 18 is caused to move outward with respect to the chamber 14, as depicted by arrow 38. The volume of the chamber 14 consequently increases and ambient fluid 39 rushes into the chamber 14, as depicted by the set of arrows 40. The diaphragm 18 is controlled by the control system 24 so that, when the diaphragm 18 moves away from the chamber 14, the vortices 4 are already removed from the orifice edges 30 and thus are not affected by the ambient fluid 39 being drawn into the chamber 14. Meanwhile, a jet of ambient fluid 39 is synthesized by the vortices 34, creating strong entrainment of ambient fluid drawn from large distances away from the orifice 16.

Some attempts have been made in the art to create synthetic jet ejectors on the micron scale. For example, U.S. Pat. No. 6,457,654 (Glezer et al.) discloses micromachined synthetic jet actuators based on MEMS technology. However, while this approach represents a notable advance in the art, further advances in the technology are still required. It has now been found that some of these needs may be met with the devices and methodologies disclosed herein.

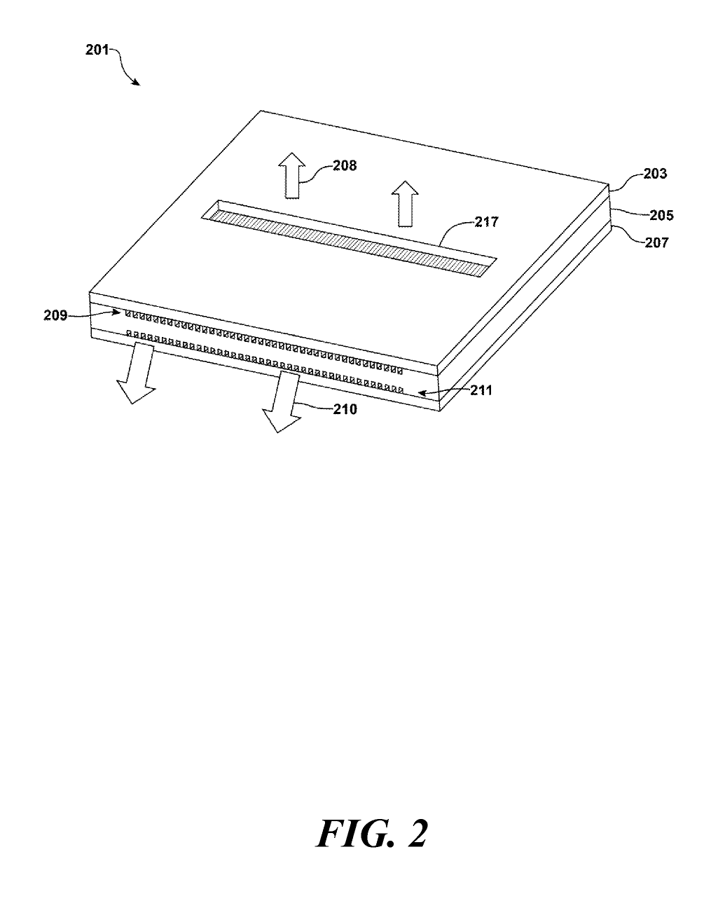

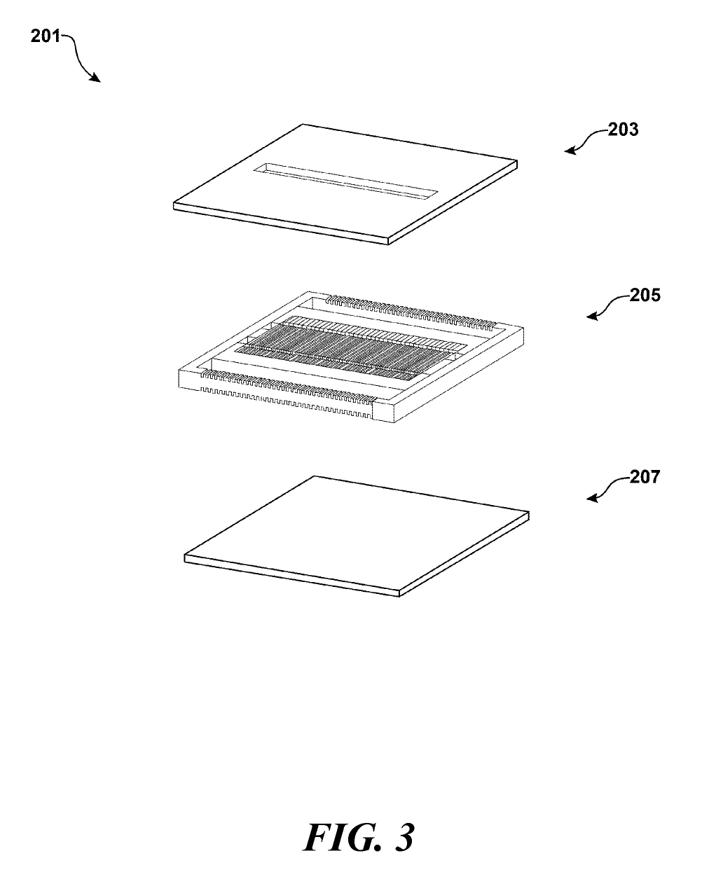

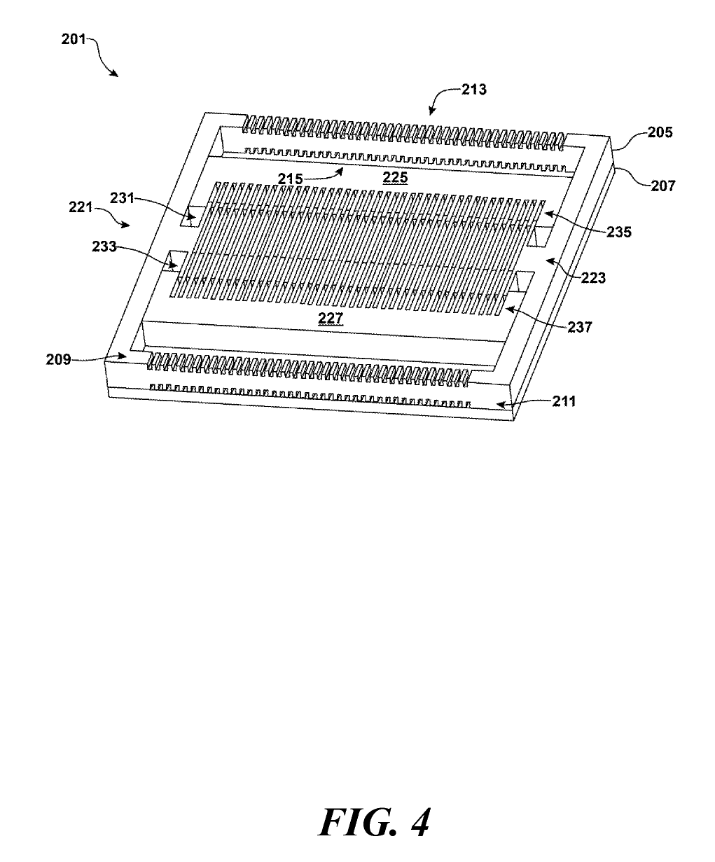

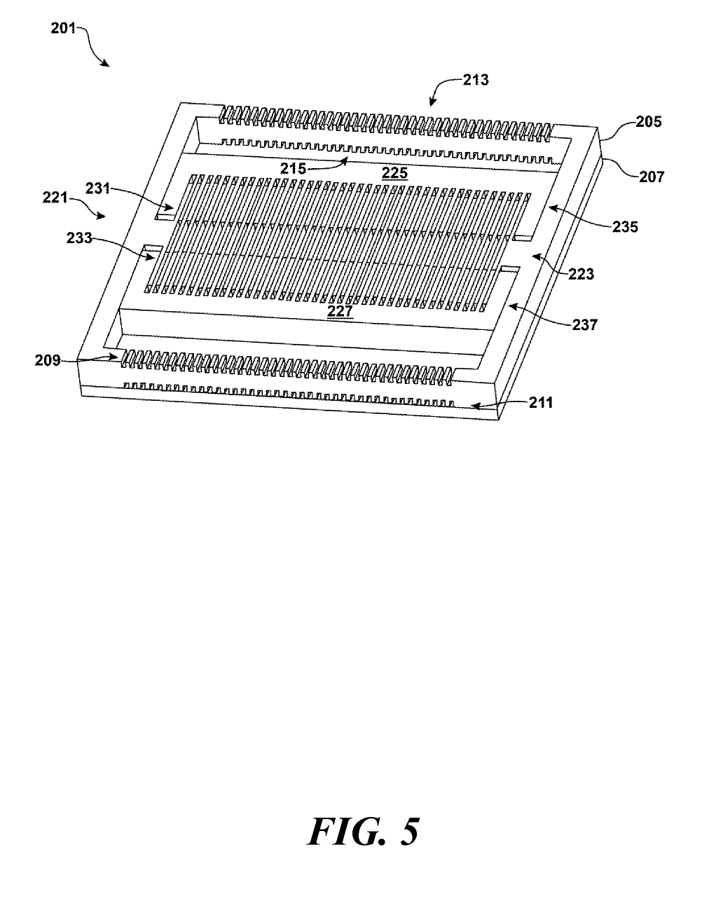

FIGS. 2-5 illustrate a first particular, non-limiting embodiment of a micromachined synthetic jet ejector in accordance with the teachings herein. As seen therein, and with respect to FIG. 2, the synthetic jet ejector 201 depicted therein includes first 203, second 205 and third 207 layers which, together, define first 209, second 211, third 213 (see FIGS. 4-5) and fourth 215 sets of apertures. The third 213 and fourth 215 sets of apertures are preferably mirror images of the first 209 and second 211 sets of apertures depicted in FIG. 2. A central aperture 217 is provided in the first layer.

As described below, the synthetic jet ejector 201 operates to produce synthetic jets (indicated generally by arrows 208 and 210 in FIG. 2) from any or all of the apertures 209, 211, 213, 215 or 217, and these synthetic jets may be used for thermal management purposes. Variations of this embodiment are possible in which the central aperture is omitted or replaced by a plurality of apertures. It will also be appreciate that, in some embodiments, any of the apertures 209, 211, 213, 215 or 217 may be nozzles, or may be conduits that emit synthetic jets in a remote location. It will further be appreciated that, while the synthetic jet ejector 201 is depicted as being generally rectangular in shape, it may assume a wide variety of shapes in different embodiments.

The first 203 and third 207 layers preferably comprise a dilectric material such as an oxide, and more preferably comprise silicon oxide. The third layer is preferably solid (that is it is devoid of apertures), although embodiments are possible in which one or more apertures are provided in this layer as well. As best seen in FIGS. 4-5, the second layer 205 is equipped with a MEMS comb drive 221 (described in greater detail below), and preferably comprises one or more semiconductor materials such as, for example, Si, Ge or alloys thereof, and more preferably comprises polysilicon.

FIGS. 4-5 illustrate the interior construction of the synthetic jet ejector 201. As seen therein, the second layer 205 includes a MEMS comb drive 221 which, in this particular embodiment, includes a stationary electrode 223 and first 225 and second 227 movable electrodes. The stationary electrode 223 has first 231 and second 233 sets of protrusions 231 thereon, and the first 225 and second 227 movable electrodes have third 235 and fourth 237 sets of protrusions 231 thereon, respectively. The first set of protrusions 231 interdigitate with the third set of protrusions 235, and the second set of protrusions 233 interdigitate with a fourth set of protrusions 237. It will be appreciated, however, that in other embodiments, only a single movable electrode may be utilized, while in still other embodiments, a plurality of stationary or movable electrodes may be utilized, and each electrode may have one or more sets of protrusions. Moreover, each set of protrusions may have one or more members, but typically has several members.

In operation, a drive voltage between the first 231 and second 233 sets of protrusions, and between the third 235 and fourth 237 sets of protrusions, causes the first movable electrode 225 and the second movable electrode 227 to move in and out with respect to the stationary electrode 223. The change in volume of the space between the interdigitated protrusions causes a fluidic flow into, and out of, the apertures 209, 211, 213, 215 and 217. This fluidic flow may comprise one or more synthetic jets if, for example, the comb drive 221 is driven at the appropriate frequency.

The operation of the comb drive may be further understood with respect to FIG. 7, which illustrates a simplified comb drive actuator. The comb drive actuator 301 depicted therein consists of two interdigitated finger structures in the form of a stationary electrode 303 and a moving electrode 305. The stationary electrode 303 is attached to a substrate by way of a plurality of anchors 307 (which may be created by the etching process used to define the finger structures), and the moving electrode 305 is supported by a compliant suspension (not shown), such as a spring through a shuttle mass plate.

The driving voltage between the comb structures is controlled by a voltage regulator 309 which causes the displacement of the moving electrode 305 toward the stationary electrode 303 (and hence the displacement of the movable fingers 311 towards the fixed fingers 313) by through attractive electrostatic force. The position of the movable finger structure is controlled by a balance between the electrostatic force and the mechanical restoring force of the compliant suspension. Thus, upon removal of the attractive electrostatic force, the moving electrode 305 will move away from the stationary electrode 303. Hence, the comb drive actuator 301 may be driven through the application of an oscillating voltage by the voltage regulator 309 to create a periodic motion between the stationary electrode 303 and the moving electrode 305. At proper frequencies, such a motion may result in fluidic motion between the host device and the ambient environment of the type required to create synthetic jets.

The capacitance of the comb drive is given by EQUATION 1:

$$C = \frac{2 n {ɛ}_{0} t ( {y}_{0} + y )}{g} \qquad ( EQUATION 1 )$$

wherein t is the thickness of comb finger, y₀ is the initial overlap, y is the comb displacement and g is the gap spacing between movable and fixed combs.

The lateral electrostatic force (Fₑₗ) in the y direction may be expressed as EQUATION 2:

$$Fel = \frac{1}{2} \frac{\partial C}{\partial y} {V}^{2} = \frac{n {ɛ}_{0} t}{g} {V}^{2} \qquad ( EQUATION 2 )$$

where V is the applied voltage between the movable and fixed combs. The displacement y (along the y-axis) of the movable plate as a function of applied force is given by EQUATION 3:

$$y = \frac{n {ɛ}_{0} {tV}^{2}}{Kg} \qquad ( EQUATION 3 )$$

wherein y is the displacement, covered by the movable comb finger from its initial overlap position in the positive y-direction when an electrostatic field (Fₑₗ) is applied to it and K is the mechanical stiffness of the flexure spring. The suspension spring (beam or cantilever) should be of sufficient flexibility in the direction of the actuation. Increasing the beam stiffness will require a large electrostatic force to cause the deflection, and consequently will require higher driving voltages. A general formula for calculating the stiffness is given by EQUATION 4:

$$K = 2 {Et [ \frac{W}{L} ]}^{3} \qquad ( EQUATION 4 )$$

wherein E is the Young Modulus for polysilicon, W is the width and L is the length of cantilever.

The device may be made through well-known semiconductor fabrication processes. These may include, but are not limited to, suitable masking and etching steps (such as, for example, DRIE or KOH etching to make, for example, the MEMS comb drive), silicon or fusion bonding (to make, for example, the overall assembly), dicing (e.g., to singulate the die), and MEMS packaging (which may include, for example, wire bonding or the use of a solder/frit-bond/adhesive to, for example, connect the device to a power supply). Preferably, at least the MEMS comb drive is fabricated from an SOI wafer, though bulk wafers may be utilized as well.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A semiconductor device which functions as a synthetic jet ejector, comprising:
a first layer;
a third layer; and
a second layer disposed between said first layer and said third layer;
wherein said second layer comprises a MEMS comb drive, wherein said device has a plurality of apertures therein which are in fluidic communication with said comb drive and which are also in fluidic communication with the external environment, and wherein said comb drive operates to generate a plurality of synthetic jets at said plurality of apertures.

2. The semiconductor device of claim 1, wherein said second layer comprises a semiconductor material, and wherein said third layer comprises an oxide.

3. The semiconductor device of claim 2, wherein the semiconductor material is selected from the group consisting of Si and Ge, and wherein said oxide is silicon oxide.

4. The semiconductor device of claim 1, wherein said first layer comprises an oxide.

5. The semiconductor device of claim 4, wherein said oxide is silicon oxide.

6. The semiconductor device of claim 1, wherein said comb drive comprises a first structure having a first set of set of protrusions and a second structure having a second set of protrusions, and wherein said second set of protrusions are arranged in an interdigitating manner with said first set of protrusions.

7. The semiconductor device of claim 6, wherein said second structure moves with respect to said first structure.

8. The semiconductor device of claim 7, wherein said first structure is stationary, and wherein said second structure oscillates between a first state in which it is closer to said first structure, and a second state in which it is further from said first structure.

9. The semiconductor device of claim 7, wherein said first structure is stationary, and wherein said second structure oscillates between a first state in which said second set of protrusions extend between said first set of protrusions to a greater degree, and a second state in which said second set of protrusions extend between said first set of protrusions to a lesser degree.

10. The semiconductor device of claim 6, wherein said first structure further comprises a third set of set of protrusions, and further comprising a third structure having a fourth set of protrusions arranged in an interdigitating manner with said third set of protrusions.

11. The semiconductor device of claim 6, wherein said third structure moves with respect to said first structure.

12. The semiconductor device of claim 11, wherein said first structure is stationary, and wherein said third structure oscillates between a first state in which it is closer to said first structure, and a second state in which it is further from said first structure.

13. The semiconductor device of claim 11, wherein said first structure is stationary, and wherein said third structure oscillates between a first state in which said fourth set of protrusions extend between said third set of protrusions to a greater degree, and a second state in which said fourth set of protrusions extend between said third set of protrusions to a lesser degree.

14. The semiconductor device of claim 8, wherein said first layer comprises an opening disposed over said first set of protrusions.

15. The semiconductor device of claim 14, wherein the oscillation of said second structure creates a fluidic flow into and out of said opening.

16. The semiconductor device of claim 14, wherein the oscillation of said second structure creates a fluidic flow into and out of said plurality of apertures.

17. The semiconductor device of claim 14, wherein the oscillation of said second structure creates a plurality of synthetic jets at said plurality of apertures.

18. A synthetic jet ejector, comprising:
a housing having a plurality of apertures defined therein;
a comb drive disposed within said housing which includes (a) a moving electrode equipped with a first set of protrusions, and (b) a fixed electrode equipped with a second set of protrusions which are arranged in an interdigitating manner with respect to said first set of protrusions; and
a controller which drives said comb drive to create at least one synthetic jet at said plurality of apertures by modifying the distance between said moving electrode and said fixed electrode.

19. The synthetic jet of claim 18, wherein said controller modifies the distance between the moving electrode and the fixed electrode by modifying the voltage between the movable and fixed electrodes.

20. The synthetic jet of claim 19, wherein said controller drives said comb drive by oscillating the voltage between the movable and fixed electrodes.
